(19) United States
(12) Patent Application Publication
(10) Pub. No.: US 2025/0353686 A1
(43) Pub. Date: Nov. 20, 2025

(54) IMPLEMENT AND METHOD FOR INJECTING A MATERIAL INTO THE GROUND

(71) Applicant: CARBON ALERT B.V., Hengelo (NL)

(72) Inventor: Jacobus Lambertus VAN MERKSTEIJN, Hengelo (NL)

(73) Assignee: CARBON ALERT B.V., Hengelo (NL)

(21) Appl. No.: 18/869,470

(22) PCT Filed: May 16, 2023
(86) PCT No.: PCT/EP2023/063143

§ 371 Date: Nov. 26, 2024

(30) Foreign Application Priority Data
May 27, 2022 (NL) 2032003

(51) Int. Cl. B65G 5/00; B62D 63/08

(52) U.S. Cl. CPC B65G 5/00; B62D 63/08

(57) ABSTRACT

An implement for injecting a material, such as biological material comprising carbon, into the ground, for instance for performing carbon sequestration. The implement includes a chassis having ground contact means, such as wheels, slides or tracks, for movably supporting the chassis on a ground surface in a movement direction. The implement further includes at least one frame with a corresponding injection device, each injection device being supported by the at least one frame. The at least one frame is reciprocally movable with respect to the chassis in the movement direction. A method of injection a material into the ground.

The invention relates to an implement for injecting a material, such as biological material comprising carbon, into the ground. The device may be used for performing carbon sequestration.

In carbon sequestration, a carbon-containing material is isolated form the carbon cycle, so as to reduce the amount of carbon in the cycle. Carbon-sequestration may be a (partial) solution to the rising levels of carbon dioxide in the atmosphere, which brings about several negative effects, the best known example being that of climate change due to the greenhouse effect. It is widely known that plants absorb carbon dioxide, and fix the carbon in other molecules via the process of photosynthesis. Normally plants decay over relatively short periods of time, thereby feeding back the carbon into the carbon cycle. By isolating plant material, the return of carbon to the cycle may be prevented, thereby thus performing carbon-sequestration. This strategy may be monetized by selling carbon rights corresponding to the sequestrated amount of carbon.

Of course carbon sequestration can be performed using any carbon containing material of non-fossil origin. In particular, biological material preferably obtained from plants is considered. In the current application, a material is sequestrated via injection into the ground. For that purpose the material may be liquid or liquid-like in substance, i.e. it may be injectable.

One way of isolating material from the carbon cycle is to store it underground. Underground storage may however be energy intensive, time intensive, require a large capital investment, or be otherwise impractical and/or uneconomical. The invention aims to at least partially alleviate said disadvantages.

This aim is achieved when the implement comprises a chassis comprising ground contact means, such as wheels, slides or tracks, for movably supporting the chassis on a ground surface in a movement direction, the implement further comprising at least one frame with a corresponding injection device, each injection device being supported by the at least one frame, wherein the at least one frame is reciprocally movable with respect to the chassis in the movement direction.

Firstly, the invention makes use of injection for bringing the material subsurface. Injection has the advantage that relatively little ground may need to be moved, thereby making injection a relatively efficient way to store material in the ground. Moreover, injection may leave a relatively large portion of the surface intact. To allow efficiently injecting material several times over, the injection device(s) are carried by a movable implement, which for the purpose has ground contact means. In order to allow movement of the implement during injection without damaging a relatively large portion of the surface, the injection device(s) is arranged on a frame which is movable with respect to a chassis. Accordingly, the implement can keep moving, that is, the chassis can keep moving, during injection. The frame may move with respect to the chassis in the direction opposite to the movement direction, so that the frame remains substantially stationary, e.g. with respect to the ground. Accordingly, injection can take place from a stationary point. After injection, the frame may move back with respect to the chassis.

It is noted that injection may thus take place intermittently. The injection device may be configured for intermittent injection. The injection device may for instance function using a piston-and-cylinder configuration, wherein the upstroke and downstroke of the piston are synchronized with the movement of the frame with respect to the chassis, so that injection takes place stationary, and so that the injection device is loaded while the frame moves back with respect to the chassis when the frame is not stationary.

The implement may further comprise an actuator connected to the frame and the chassis, the actuator being arranged to move the frame with respect to the chassis in at least one direction.

Using the actuator, suitable movement of the frame and the chassis may be obtained. It is possible the actuator is configured to move the frame in one, but not the opposite direction. The frame may therefore be free to move in one direction with respect to the chassis, whilst it is driven intermittently in the other direction by the actuator. Movement of the frame in the direction in which it is free to move may be obtained by the injection device contacting the ground, thereby acting as an anchor. Of course, it is also possible to drive the frame with respect to the chassis using the actuator (or different actuators) in both directions.

One method of suitably driving the frame, is when the frame and the chassis are connected via a tensile element, wherein the actuator is configured for pulling the frame with respect to the chassis via the tensile element.

A relatively light-weight construction may be obtained accordingly.

The implement may comprise multiple such frames arranged longitudinally and/or transversally as seen in the movement direction.

Accordingly, the injection capacity of a single implement may be increased. Moreover, when injection devices are synchronized out of phase, injection may take place with a relatively constant total flow across the multiple injection devices. Accordingly, the implement is able to more effectively deal with a constant influx of material to be introduced into the ground. Of course, this effect can also be achieved by arranging multiple injection devices on a single frame.

The multiple frames may be arranged stationarily in the direction in which they move with respect to the chassis, thereby allowing the frames to be arranged closer to each other.

It is also possible to move the frames out-of-phase with respect to each other, thereby also smoothing out the injection process and/or any energy consumption associated with moving the frame with respect to the chassis.

In order to allow the out-of-phase movement of the frames, the multiple frames may be independently movable with respect to the chassis. Independently moving the frames allows suitably driving them for creating a near-continuous injection process. It is also possible to move the frames dependently, but out of phase. A mechanism linking movement of the frames may be arranged therefor. The mechanism may consist of a mechanical linkage, or an electronically controlled drive means, which is configured for causing the desired out-of-phase, but synchronized, movement of the frames.

It is noted that it is also possible to arrange multiple, such as two, injection devices and optionally associated equipment on a single frame.

The injection device may comprise an injector needle which is movable with respect to the frame reciprocally between an extended position, in which it extends beyond the ground contact means, and a retracted position in which it does not extend beyond the ground contact means.

Accordingly, the needle may be inserted into an retracted from the ground. When the needle is inserted into the ground, material may be ejected from the needle, in order to inject into the ground at a distance below the surface. When the needle is retracted, the injector device may be moved together with the frame with respect to the ground, without damaging the surface.

The injector needle may for instance be telescopically extendable in order to achieve the reciprocal behaviour described above.

In a particular embodiment, the injector needle comprises an exit opening in a free end zone thereof, the exit opening being arranged on a side of the injector needle. The exit opening may normally be arranged on the longitudinal end of the needle, so that ejection takes place in the longitudinal direction of the needle. However in this embodiment, ejection may take place sideways in order to better distribute the ejected material in the ground. Multiple such exit openings, such as two, three or four, may be arranged in the needle's side.

The implement may further comprise a pressure cylinder fluidically connected to the injection device via a conduit and a piston configured for cooperating with the pressure cylinder to drive a fluid through the conduit.

The pressure cylinder and piston may together produce sufficient pressure for injection material into the ground.

Practically, the piston may be hydraulically operated.

The pressure cylinder may include an inlet, and a one-way valve associated with the inlet, allowing inflow into, but not outflow out of the pressure cylinder through the inlet.

In this case, feeding material into the pressure cylinder becomes relatively easily. In particular, filling the pressure cylinder may take place with the aid of, or exclusively by, movement of the piston in the cylinder, which may effectively pull in material during its filling stroke (e.g. the upstroke).

To guarantee sufficient material is provided to the injection device, a pump may be provided, preferably a lobe pump, for supplying material to the injection device, preferably via the pressure cylinder.

A lobe pump may be particularly suited for transporting the material involved in this application, and may be less susceptible to wear.

The implement may further comprise a measurement unit arranged for measuring the amount of carbon injected into the ground. The measurement unit may be arranged downstream of the pump. The measurement unit may include spectroscopic measurement device configured for measuring the amount of carbon per unit of material, and a flow meter configured for measuring the amount of material injected into the ground. The flow meter may measure a volumetric flow, or a mass flow.

The implement may further comprise a processor for homogenizing e.g. biological material.

Using the processor, raw material may be processed as a homogenized mass, thereby being capable of being injected and/or transported using the pump.

The processor may comprise at least one roller extending at a non-zero distance from a pressing surface for pressing the material between the at least one roller and the pressing surface.

Using a roller sufficient pressure may be applied on the material to homogenize it. Keeping a non-zero distance between the roller and the pressing surface, which may also be that of a roller, increases energy efficiency and reduces wear, yet does not detriment the homogenizing result when the distance is kept sufficiently small.

Of course the implement may further include a mowing and/or harvesting system. Accordingly the implement may be a complete system which harvests, processes, and injects material. The implement may therefore be driven across land upon which the plants grow. Harvesting may take place during injection, thereby obtaining a highly efficient system.

The implement may comprise a coupling attached to the chassis for pulling the implement in the movement direction. Accordingly, the implement becomes suitable for use via e.g. a tractor or other type of prime mover. As an alternative, the implement may itself comprise a prime mover coupled to the chassis. The implement may be self-driving, i.e. not requiring human operation.

The invention also relates to a method of injecting material, such as carbon containing material, for instance of biological origin, into the ground, comprising:
a Moving a chassis in a movement direction over a ground surface, whilst carrying an injection device on a frame supported by the chassis;
b. During step a., moving the frame in an opposite direction with respect to the chassis, so that the frame is stationary with respect to the ground surface;
c. During step b., injecting the material in a ground layer below the ground surface; and
d. After step c., moving the frame in the movement direction with respect to the chassis.

The method may be performed by using the implement as described herein. The method may bring about the advantages and effect described above in relation to the implement.

The invention will be further elucidated with reference to the figures, in which:

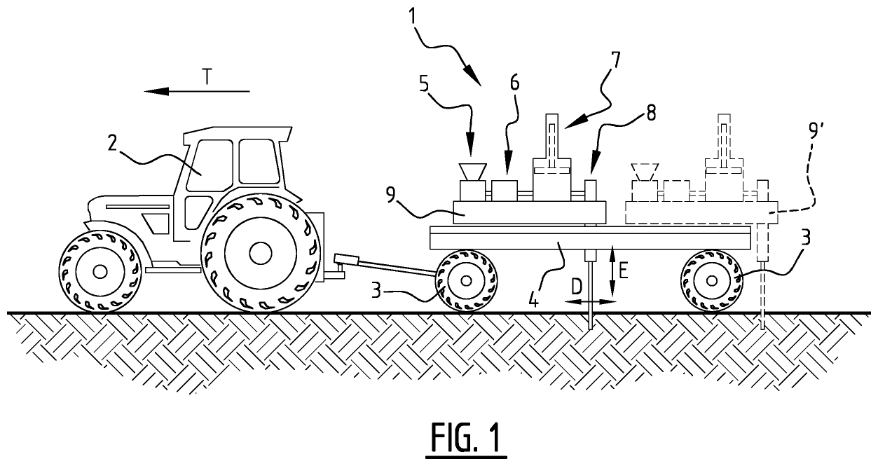

FIG. 1 shows schematically a side view of a tractor and an implement as described herein;

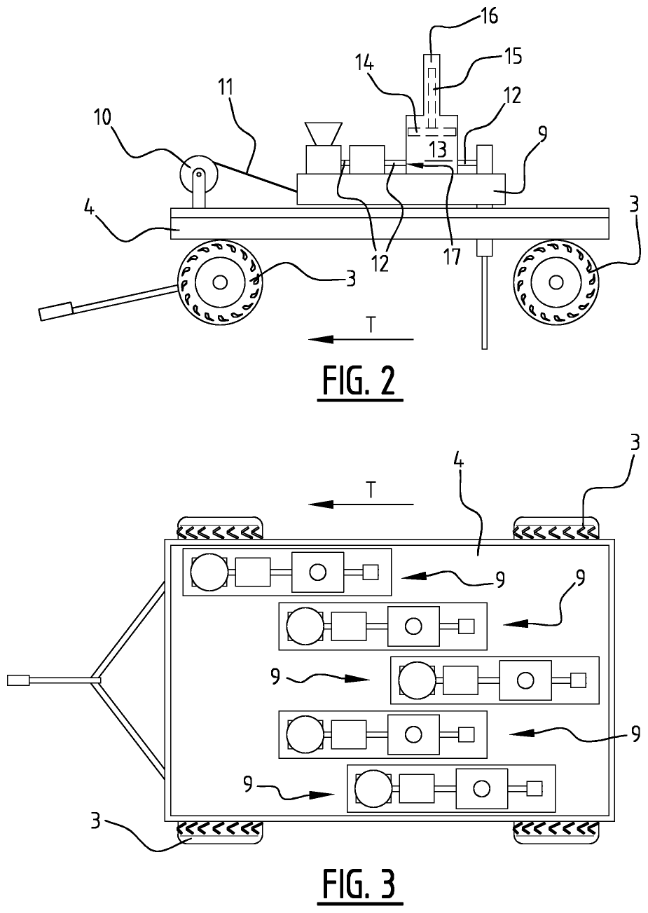

FIG. 2 shows schematically some more details of the implement of FIG. 1;

FIG. 3 shows schematically a top view of another implement;

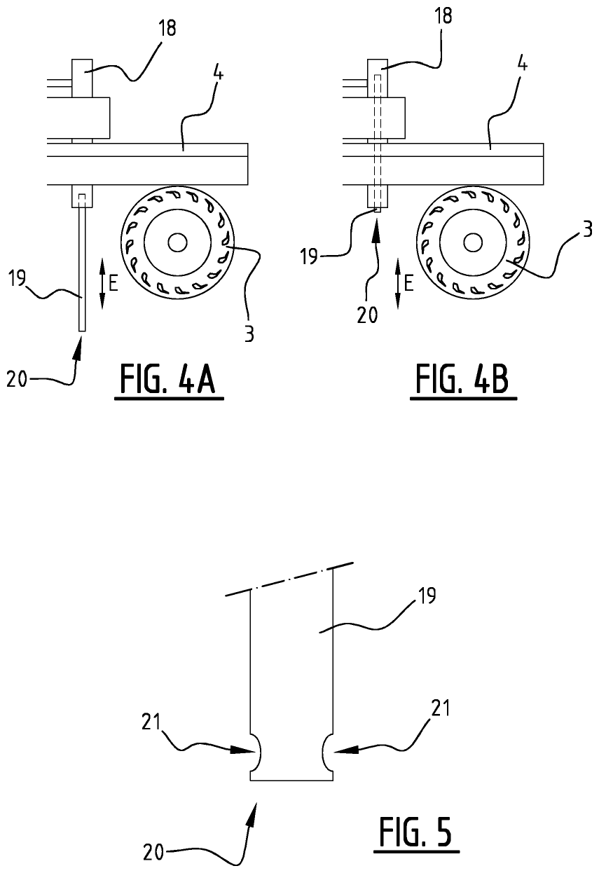

FIGS. 4A and 4B show schematically a detailed side view of an implement with extended and retracted injector needle respectively; and

FIG. 5 shows schematically a front view of the free end of an injector needle.

Throughout the figures, like elements are referred to using like reference numerals.

FIG. 1 shows an implement 1 coupled to a tractor 2 so that it can be transported in a transport direction T. the implement comprises wheels 3 carrying a chassis 4. The implement further comprises a processor 5, a lobe pump 6, a pressure cylinder 7 and an injection device 8. The processor 5, the lobe pump 6, the pressure cylinder 7 and the injection device 8 are carried by a frame 9. The frame 9 is movable in a direction D parallel to the transport direction T with respect to the chassis 4. Accordingly, the frame 9 may move backwards to an aft position as shown in dotted lines 9′. It is noted that the processor 5 and/or the pump 6 and/or the pressure cylinder 7 may alternatively be arranged stationarily with respect to the chassis 4.

FIG. 2 shows an option for allowing rearward movement of the frame 9 by slacking a line 11 via a lynch 10. The lynch 10 is powered and controlled to move the frame 9 forward when desired, by pulling on the line 11. FIG. 2 further shows conduits 12 connecting the processor 5, the lobe pump 6, the pressure cylinder 7 and the injection device 8. The pressure cylinder 7 cooperates with a piston 14 driven by a rod 15 via a hydraulic actuator 16. The pressure cylinder includes a space 13 in which material can be received via an inlet 17 and forced out towards the injection device 8 by movement of the piston 14. A valve is arranged at the inlet 17 to prevent backflow of the material in the space 13.

FIG. 3 shows a chassis 4 with several frames 9 arranged thereon. As seen from the transport direction T, the frames 9 are arranged transversally next to each other, however frames 9 could also be arranged longitudinally behind each other additionally or alternatively. Different positions of the frames 9 show that they are independently movable in the direction D parallel to the transport direction T.

FIGS. 4A and 4B show in more detail an injection device 8, which includes a cylinder 18 and an injector needle 19. the injector needle 19 is movable telescopically in a vertical direction, which is substantially perpendicular to the transport direction and substantially perpendicular to the transversal direction. Accordingly, the injector needle 19 can be extended telescopically to beyond the wheels 3 as shown in FIG. 4A, and retracted as shown in FIG. 4B. Accordingly, the needle 19 may be inserted into the ground for injection one moment, and retracted above ground for horizontal movement in another moment. The needle 19 has a free end 20 on its downward side, from which material can eject. The free end is shown in FIG. 5 to have, optionally, side openings 21. In this particular case two side openings 21 have been provided on opposing transversal sides of the needle 19.

Although the invention has been described above with reference to particular embodiments and examples, the invention is not limited thereto. In fact, the invention also described the claims.

1. An implement for injecting a material into the ground, the implement comprising:
a chassis comprising ground contact means for movably supporting the chassis on a ground surface in a movement direction,
the implement further comprising at least one frame with a corresponding injection device, each injection device being supported by the at least one frame,
wherein the at least one frame is reciprocally movable with respect to the chassis in the movement direction.

2. The implement according to claim 1, further comprising an actuator connected to the frame and the chassis, the actuator arranged to move the frame with respect to the chassis in at least one direction.

3. The implement according to claim 2, wherein the frame and the chassis are connected via a tensile element, wherein the actuator is configured for pulling the frame with respect to the chassis via the tensile element.

4. The implement according to claim 1, comprising multiple such frames arranged longitudinally and/or transversally as seen in the movement direction.

5. The implement according to claim 4, wherein the multiple frames are independently movable with respect to the chassis.

6. The implement according to claim 1, wherein the injection device comprises an injector needle which is movable with respect to the frame reciprocally between an extended position, in which it extends beyond the ground contact means, and a retracted position in which it does not extend beyond the ground contact means.

7. The implement according to claim 6, wherein the injector needle is telescopically extendable.

8. The implement according to claim 1, wherein the injector needle comprises an exit opening in a free end zone thereof, the exit opening being arranged on a side of the injector needle.

9. The implement according to claim 1, further comprising a pressure cylinder fluidically connected to the injector via a conduit and a piston configured for cooperating with the pressure cylinder to drive a fluid through the conduit.

10. The implement according to claim 9, wherein the piston is hydraulically operated.

11. The implement according to claim 9, wherein the pressure cylinder includes an inlet and a one-way valve associated with the inlet, allowing inflow into, but not outflow out of the pressure cylinder through the inlet.

12. The implement according to claim 1, further comprising a pump, preferably a lobe pump, for supplying material to the injection device, preferably via the pressure cylinder.

13. The implement according to claim 1, further comprising a processor for homogenizing e.g. biological material.

14. The implement according to claim 13 the previous claim, wherein the processor comprises at least one roller extending at a non-zero distance from a pressing surface for pressing the material between the at least one roller and the pressing surface.

15. The implement according to claim 1, further comprising a coupling attached to the chassis for pulling the implement in the movement direction.

16. A method of injecting material into the ground, comprising:
a. Moving a chassis in a movement direction over a ground surface, whilst carrying an injection device on a frame supported by the chassis;
b. During step a., moving the frame in an opposite direction with respect to the chassis, so that the frame is stationary with respect to the ground surface;
c. During step b., injecting the material in a ground layer below the ground surface; and
d. After step c., moving the frame in the movement direction with respect to the chassis.

17. The implement according to claim 1, wherein the contact means comprise wheels, slides, or tracks.

18. The implement according to claim 1, wherein he material is a biological material comprising carbon.

19. The method of claim 16 wherein the material is a carbon containing material of biological origin.
